(19) United States
(12) Patent Application Publication
(10) Pub. No.: US 2009/0025534 A1
(43) Pub. Date: Jan. 29, 2009

(54) Device for practicing percussion instrument technique

(76) Inventor: Peter Gropp, Melbourne (AU)

Correspondence Address: PETER GROPP, 24 LINDSAY STREET, BULLEEN, MELBOURNE, 3105, AU

(21) Appl. No.: 11/419,504

(22) Filed: May 21, 2006

Related U.S. Application Data
(60) Provisional application No. 60/594,953, filed on May 22, 2005.

(51) Int. Cl. G10D 13/02

(52) U.S. Cl. 84/422.4

(57) ABSTRACT

A device for practicing percussion instrument technique includes a shaft portion and a feedback portion. The feedback portion is movable relative to the shaft portion and provides feedback to the user when an appropriate technique is used by the user of the device.

The present invention relates to a device for practising percussion instrument technique and, in particular, to a practice drumstick which allows a drummer to train wrist technique with or without the use of drums or practice drums. This Application claims benefit of U.S. Provisional Application No. 60/594,953, filed May 22, 2005.

### BACKGROUND OF THE INVENTION

Skilled drumming requires precision and control of both the down-stroke and up-stroke of the drum stick. As mentioned in US patent specification 2004/0025664, the control, stamina, speed, timing, consistency, force and precision of the down-stroke is dependent upon the preceding up-stroke which positions the stick to strike and sets the position of the hands and arms, and prepares the muscles to deliver the desired down-stroke. It is understood that the down-stroke is a reflex action whereas the upstroke requires training and muscle development to enhance this action.

Although practice drumsticks are well known in the art (for example U.S. Pat. No. 4,557,176), the majority of such practice drumsticks provide only for training the down-stroke of the drumming action.

US patent application 2004/0025664 discloses a method and device for training both the up and down-strokes of the drumming action, but requires the use of a ‘practice bar’ installed above the surface being struck on the down-stroke. Use of such a practice bar is disadvantageous because it requires a relatively large amount of space to be devoted to a practice area, and is not readily movable to different locations.

It would be desirable, therefore, to provide drummers with portable means to effectively practice both the up and down-stroke actions.

### SUMMARY OF THE INVENTION

In accordance with one aspect of the present invention there is disclosed a device for practising percussion instrument technique, the device including a shaft portion and a feedback portion, wherein the feedback portion is movable relative to the shaft portion and provides feedback to the user of the device upon predetermined movement of the device.

The shaft portion of the device may be of solid or hollow construction, and may be made of any appropriate material such as timber, metal, alloy or plastic. The shaft may also be tapered. Preferably, the shaft portion of the device is fitted with a grip portion at one end. The invention may also include a stop portion at the opposite end to the grip portion. The shaft portion may be telescopic.

Preferably the feedback portion is slidable relative to the shaft portion, with the striking of the feedback portion against a portion of the shaft portion providing audible and vibrational feedback to the user. For example, the feedback portion may strike against the stop portion. In using the device, depending on the weight of the feedback portion and the length of travel, the user will be required to exert some force in his up-stroke action for the feedback portion to reach the stop device, thereby strengthening the up-stroke action in the user. Repetition of this action builds and strengthens the up-stroke action.

In one embodiment of the invention, the feedback portion may comprise a block with a hole or recess cooperable with the shaft portion of the device to facilitate the slidable movement of the feedback portion between the grip portion and the stop member. For example, the feedback portion may comprise a toroidal block which slides externally on the shaft portion.

However, beyond a sliding movement, other kinds of relative movement are included within the scope of the invention. In another possible embodiment, the feedback portion may be pivotably mounted to the shaft portion. For example, the feedback portion may be pivotally connected to the shaft portion of the device. This may be achieved in a plastic moulded shaft portion with an integrally moulded feedback portion, whereby the connection between the shaft portion and the feedback portion is a flexible hinge.

In a further alternative, the shaft portion of the device includes a hollow portion and the feedback portion comprises of a movable object enclosed within the hollow portion of the shaft portion. For example, a ball bearing may be encased within a hollow portion of the drumstick. To facilitate this embodiment, the stop portion may removably attached to the shaft portion of the device.

In a most preferred form of the invention, the shaft portion has an internal bore with a slidable block or weight provided therein. The block or weight may be removable from the internal bore to enable substitution of a block or weight of a different weight. The proximal end of the shaft portion opposite the tip is provided with a removable end cap to enable removal of the block or weight. The end cap may incorporate an elongate stop portion which extends into the internal bore, the distal end of which defines a proximal stop for the block or weight. The distal end of the internal bore may define a distal stop for the block or weight.

In the above described embodiments, movement of the feedback portion of the device provides audible and vibrational feedback, for example by the feedback portion striking another part of the shaft portion of the device. Alternatively, the feedback provided may be visual, for example by means of an electronic sensor mounted in the shaft portion to detect movement of the feedback portion and provide an indicator light upon detection of appropriate movement of the feedback portion of the device.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

### BRIEF DESCRIPTION OF DRAWINGS

FIG. 1 which is a schematic view of a device according to a first preferred embodiment of the present invention;

FIG. 2 which is a schematic view of a second embodiment of the invention;

FIG. 3 is an cross-sectional view showing a device according to a third preferred embodiment of the present invention; and

FIG. 4 is a cross-sectional view of a fourth preferred embodiment of the invention.

### DETAILED DESCRIPTION

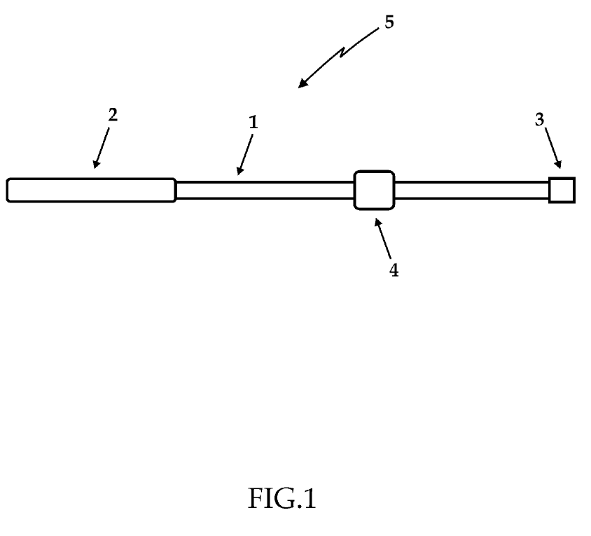

With reference to FIG. 1, one embodiment of the invention comprises a device 5 for practising percussion technique. The device 5 comprises a shaft portion 1 having a hand grip 2 with a stop portion 3 at the other end of the shaft portion 1 from the hand grip 2. The user operates the device in a mode similar to the operation of a traditional drumstick by gripping the hand grip 2 and striking the stop portion 3 against a drum or other percussive surface. Alternatively, the device 5 could be used in the free air, without the use of a striking surface.

The device further includes a feedback portion in the form of a collar 4 slidably engaged with the shaft portion 1. The collar 4 can slide between the grip portion 2 and the stop portion 3. When the practice device is correctly used, the user attempts to perform the up-stroke so that the collar 4 strikes the stop portion 3 of the shaft, emitting audible, visual, and vibrational feedback to the user. This action, when performed on a repeated basis serves to strengthen the up-stroke action of the user.

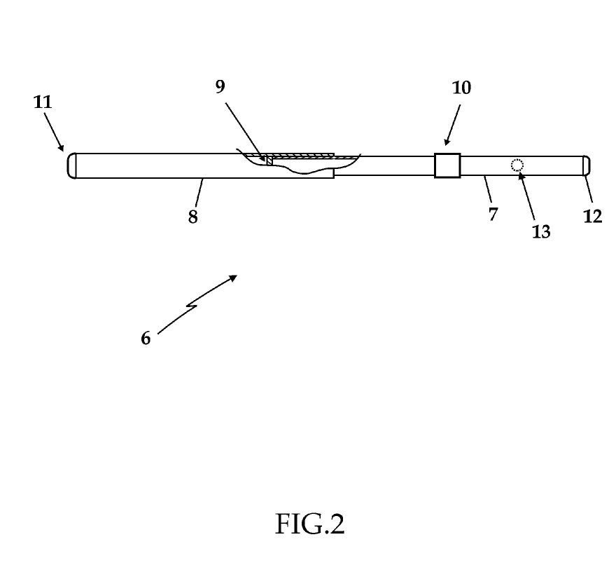

FIG. 2 illustrates an alternative embodiment where the device 6 is made up of two telescopically slideable sections 7,8 of the shaft portion. The sections 7,8 are tubular in form with the outer ends closed by means of plastic end caps 11,12. The diameter of the tubes is selected such that the sections 7,8 may be easily slideable relative to one another. The device 6 may be provided with an internal locking device 9 to lock the two sections 7,8 in fixed disposition. A fixed plastic collar 10 will determine the minimum length of the device 6. The ability to lengthen or shorten the device will alter the weight distribution and in turn will alter the effort required to operate the device. The feed back portion comprises a ball-bearing 13 within the hollow section 7.

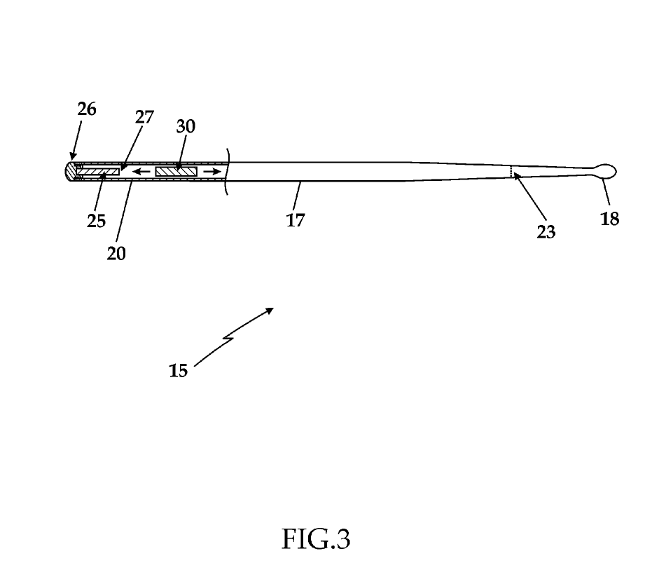

FIG. 3 illustrates a third preferred practice device 15 comprised of a hollow shaft portion 17 having a tip 18 formed at its distal end. The shaft portion 17 may be constructed from plastic or metal such as aluminum or from timber. A grip portion 20 is provided at the proximal end of the shaft portion. The grip portion 20 may be integral with the remainder of the shaft portion. For example, the metal shaft portion may be knurled or textured so as to provide a grip portion. Alternatively, the grip portion 20 may be provided by an outer layer of rubber or plastic. The shaft portion 17 may be hollow for the whole of its length. Alternatively, the distal tip 18 may be solid, thereby defining a distal stop 23.

At the proximal end of the shaft portion 17, a removable end cap 26 threadingly engages with the proximal end. The end cap 26 has an elongate stop portion 25. The end 27 of the stop portion defines a proximal stop. A block or weight 30 is inserted into the internal bore of the shaft portion. When the end cap 26 is secured, the block can freely slide between the proximal stop 27 and the distal stop 23. Alternatively, the block or weight 30 can be removed to enable the practice device to be also used in a normal playing mode. This gives the device a dual purpose.

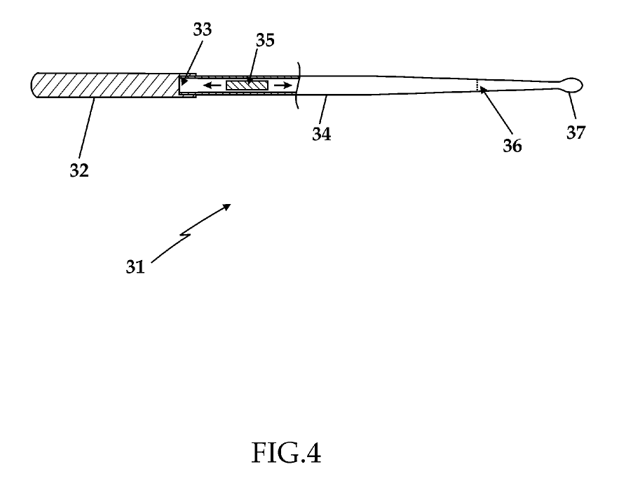

FIG. 4 shows another embodiment of the device which is similar in many respects to that of FIG. 3. At the proximal end of the device 31, the grip portion 32 is formed as a solid body and thus defines the proximal stop 33. The grip portion 32 may be removably mounted on the end of the shaft portion 34 to facilitate manufacture and assembly. Alternatively, the grip portion 32 may be integrally formed as part of the shaft portion 34.

In use, the block or weight 35 will freely slide within the internal bore of shaft portion 34 and strike against the distal stop 36 and the proximal stop 33. The striking of the block 35 against the stops will provide an audible noise or vibrational feedback to the user to ascertain that they have moved the device in the correct manner. Alternatively, the distal tip 37 may be solid, thereby defining a distal stop 36.

What is claimed is:

1. A device for practicing percussion instrument technique, the device including a shaft portion and a feedback portion, wherein the feedback portion is movable relative to the shaft portion and provides feedback to the user of the device upon predetermined movement of the device.

2. The device of claim 1 wherein the feedback provided is audible feedback.

3. The device of claim 1 wherein the feedback provided is visual feedback.

4. The device of claim 1 wherein the feedback provided is vibrational feedback.

5. The device of claim 1 wherein the feedback portion is slidable relative to the shaft portion of the device.

6. The device of claim 5 wherein the shaft portion includes one or more stop members against which the feedback portion may strike.

7. The device of claim 1 wherein the shaft portion includes a grip portion at one end and a stop portion towards the opposite end of the shaft portion and the feedback portion slides externally of the shaft portion between the grip portion and the stop portion.

8. The device of claim 1 wherein the feedback portion is pivotally connected to the shaft portion of the device.

9. The device of claim 5 or 6 wherein the feedback portion is in the form of a toroidal block slidably mounted on the shaft portion.

10. The device of claim 1 wherein the shaft portion has two sections which are telescopically slidable.

11. The device of claim 1 wherein the shaft portion includes an internal bore and the feedback portion is in the form of a block or weight slidably mounted within the internal bore.

12. The device of claim 11 having a distal end in the form of a tip and a proximal end, wherein the proximal end is provided with a replaceable end cap to access the internal bore.

13. The device of claim 12 wherein device is in the form of a drumstick and the block or weight is removable and the end cap is replaceable to enable use of the drumstick in a normal manner.

14. The device of claim 1 or claim 11 wherein the device is in the form of a drumstick.
